(19) United States
(12) Patent Application Publication
(10) Pub. No.: US 2025/0287406 A1
(43) Pub. Date: Sep. 11, 2025

(54) TECHNIQUES FOR SELECTING RESOURCES FOR JOINT COMMUNICATION AND RADAR SIGNALS IN WIRELESS COMMUNICATIONS

(71) Applicant: QUALCOMM Incorporated, San Diego, CA (US)

(72) Inventors: Preeti KUMARI, San Diego, CA (US); Shuanshuan WU, San Diego, CA (US); Stelios STEFANATOS, San Diego, CA (US); Kapil GULATI, Belle Mead, NJ (US); Junyi LI, Greentown, PA (US)

(21) Appl. No.: 19/105,027

(22) PCT Filed: Oct. 16, 2023
(86) PCT No.: PCT/US2023/076982

§ 371 Date: Feb. 19, 2025

(30) Foreign Application Priority Data
Oct. 21, 2022 (GR) 20220100866

(51) Int. Cl. H04W 72/25; H04W 64/00; H04W 72/0446

(52) U.S. Cl. CPC H04W 72/25; H04W 64/003; H04W 72/0446

(57) ABSTRACT

Aspects described herein relate to sensing sidelink communications during a sensing window, configuring, in a time period following the sensing window and based on resources predicted as available in the time period based on the sidelink communications, resources for a comb pattern including a collection of resource elements in a subset of multiple time resource locations within the time period for transmitting a radar signal that includes a data channel communication, and transmitting or receiving, using the comb pattern, the radar signal to or from the one or more other UEs over sidelink shared channel resources.

### CROSS-REFERENCE TO RELATED APPLICATIONS

This application claims the benefit of Greek Provisional Patent Application No. 20220100866, entitled TECHNIQUES FOR SELECTING RESOURCES FOR JOINT COMMUNICATION AND RADAR SIGNALS IN WIRELESS COMMUNICATIONS, and filed on Oct. 21, 2022, which is expressly incorporated by reference herein in its entirety.

### FIELD OF THE DISCLOSURE

Aspects of the present disclosure relate generally to wireless communication systems, and more particularly, to techniques for communicating joint communication and radar signals.

### DESCRIPTION OF RELATED ART

Wireless communication systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, and orthogonal frequency-division multiple access (OFDMA) systems, and single-carrier frequency division multiple access (SC-FDMA) systems.

These multiple access technologies have been adopted in various telecommunication standards to provide a common protocol that enables different wireless devices to communicate on a municipal, national, regional, and even global level. For example, a fifth generation (5G) wireless communications technology (which can be referred to as 5G new radio (5G NR)) is envisaged to expand and support diverse usage scenarios and applications with respect to current mobile network generations. In an aspect, 5G communications technology can include: enhanced mobile broadband addressing human-centric use cases for access to multimedia content, services and data; ultra-reliable-low latency communications (URLLC) with certain specifications for latency and reliability; and massive machine type communications, which can allow a very large number of connected devices and transmission of a relatively low volume of non-delay-sensitive information.

In 5G NR, for example, devices can transmit radar signals to indicate presence of the device to other nearby devices. In some implementations, the radar signals can be transmitted as, or along with, data signals in a joint communication and radar system.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

According to an aspect, a method for wireless communication at a UE is provided that includes sensing sidelink communications during a sensing window, configuring, in a time period following the sensing window and based on resources predicted as available in the time period based on the sidelink communications, resources for a comb pattern including a collection of resource elements in a subset of multiple time resource locations within the time period for transmitting a radar signal that includes a data channel communication, and one of transmitting, using the comb pattern, the radar signal to one or more other UEs over sidelink shared channel resources, or receiving, using the comb pattern, the radar signal from one or more other UEs over sidelink shared channel resources.

In a further aspect, an apparatus for wireless communication is provided that includes a transceiver, a memory configured to store instructions, and one or more processors communicatively coupled with the transceiver and the memory. The one or more processors are configured to execute the instructions to perform the operations of methods described herein. In another aspect, an apparatus for wireless communication is provided that includes means for performing the operations of methods described herein. In yet another aspect, a computer-readable medium is provided including code executable by one or more processors to perform the operations of methods described herein.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates an example of a wireless communication system, in accordance with various aspects of the present disclosure;

FIG. 2 is a diagram illustrating an example of disaggregated base station architecture, in accordance with various aspects of the present disclosure;

FIG. 3 is a block diagram illustrating an example of a user equipment (UE), in accordance with various aspects of the present disclosure;

FIG. 4 is a block diagram illustrating an example of a base station, in accordance with various aspects of the present disclosure;

FIG. 5 illustrates an example of a sidelink resource allocation, in accordance with aspects described herein;

FIG. 6 is a flow chart illustrating an example of a method for selecting resources for transmitting or receiving a joint communication and radar (JCR) signal as a radar signal that include sidelink (SL) communications, in accordance with aspects described herein;

FIG. 7 illustrates an example of a SL resource allocation in a resource selection window, in accordance with aspects described herein; and

FIG. 8 is a block diagram illustrating an example of a multiple-input multiple-output (MIMO) communication system including a base station and a UE, in accordance with various aspects of the present disclosure.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

The described features generally relate to selecting a portion of a period of time for selecting time and/or frequency resources for transmitting joint communication and radar (JCR) signals. In one example, the time and/or frequency resources can be selected or otherwise defined in a comb pattern. In some wireless communication technologies, such as fifth generation (5G) new radio (NR), JCR systems can include cooperative JCR systems where some knowledge is shared between the communication and radar systems to improve performance without minimal alteration of the core operation of radar and communication systems, or a co-design of the communication and radar system where a common transmitter or receiver is used for both communication and radar functionalities. Co-designed JCR systems can use a slightly modified waveform generation or receiver processing by the communication and/or radar systems. In an example, at least co-designed JCR systems can allow for spectrum and hardware reuse, which can conserve resource utilization and power consumption at devices communicating the JCR signals.

In one specific example, cyclic prefix (CP)-orthogonal frequency division multiplexing (OFDM) data signals can be used for radar sensing as well. If symbol length is less than radar channel delay spread for radar sensing, a multi-fast Fourier transform (FFT) algorithm can be used for radar detection and estimation. In some examples, multi-FFT per symbol algorithm can meet maximum automotive range requirement of 300 meters in single-target scenario with minimum detectable signal-to-interference-and-noise ratio (SINR) of 15 decibel (dB). One approach to mitigate large symbol energy loss due to long delay spread is to use one-tap frequency domain equalization (FDE) with multi-FFT windows per symbol. For example, for 480 kilohertz (kHz) subcarrier spacing (SCS): First range FFT window for k^{th} symbol can remain the same as the baseline processing (one-tap FDE with single-FFT window per symbol); Second range FFT window for k^{th} symbol can start where the first window corresponding to that symbol ends to fully capture the received k^{th} symbol; Multi-FFT per symbol target detection can be performed based on a first range-Doppler (RD) map estimate, which can have high target SINR for small ranges (with delay bin (d) less than ¼^{th} of FFT size (M_{FFT}), i.e., d<M_{FFT}/4), where RD map estimate can have high target SINR for large ranges (d>3M FFT/4), and RD map obtained by adding both the RD map estimates (leads to noise enhancement) can have high target SINR for medium ranges (M_{FFT}/4<d<3M_{FFT}/4). In general, radar sensing using data part can also enable enhanced JCR performance as compared to time division multiplexing (TDM) approach. In addition, for example, 2-RF performance may be better than 1-RF JCR, where 2-RF performance can be achievable with different waveforms (e.g., with no cross-layer interference).

Using JCR signals, for example, contiguous block of data for simultaneous sensing may lead to large communication overhead due to stringent radar sensing needs, such as wide angular field of view (FoV) with high angular resolution, which may use more beams for scanning mode, high velocity (large coherent processing interval (CPI) and range resolution (large bandwidth), high update rate and high density of radars, etc. In addition, for example, data comb transmission in time-frequency domain may be used to meet radar sensing key performance indicator (KPI) requirements without significant reduction in communication data rate. This may also enable better interference management. In some examples, different time and/or frequency comb designs and signaling for JCR application that can meet radar resolution requirements with less overhead to communication data rate.

For example, in 5G NR, time resources can include symbols, such as orthogonal frequency division multiplexing (OFDM) symbols, single carrier-frequency division multiplexing (SC-FDM) symbols, etc., slots of multiple symbols, etc. A coherent processing interval (CPI, also referred to as a radar frame) for radar signals can include multiple slots. When time comb patterns are used to select resources for JCR signals, and/or when autonomous selection of resources by user equipment (UEs) is otherwise enabled, different slots of the CPI may have different resource utilization levels. Aspects described herein relate to selecting portions of a CPI (e.g., slots) for JCR signals based on predicted resource utilization, priority of the traffic to be transmitted, etc. For example, UEs can have resources allocated for sidelink communications using type 1 sidelink resource allocation, e.g., as defined in 5G NR, where a base station can allocate the resources for each sidelink transmitting UE to use, or type 2 sidelink resource allocation, e.g., as defined in 5G NR, where the base station can allocate a pool of resources from which sidelink transmitting UEs can select for use in transmitting sidelink communications. Selecting the time resources for JCR signaling based on sensing can allow for improved resource utilization, which can improve usage of the data comb patterns in the time and/or frequency domain. This can allow for high density of radar signals to improve radar operations, and can enable the radar sensing with low data rate overhead, which can enable more efficient resource utilization, and thus communication efficiency and quality at the UE.

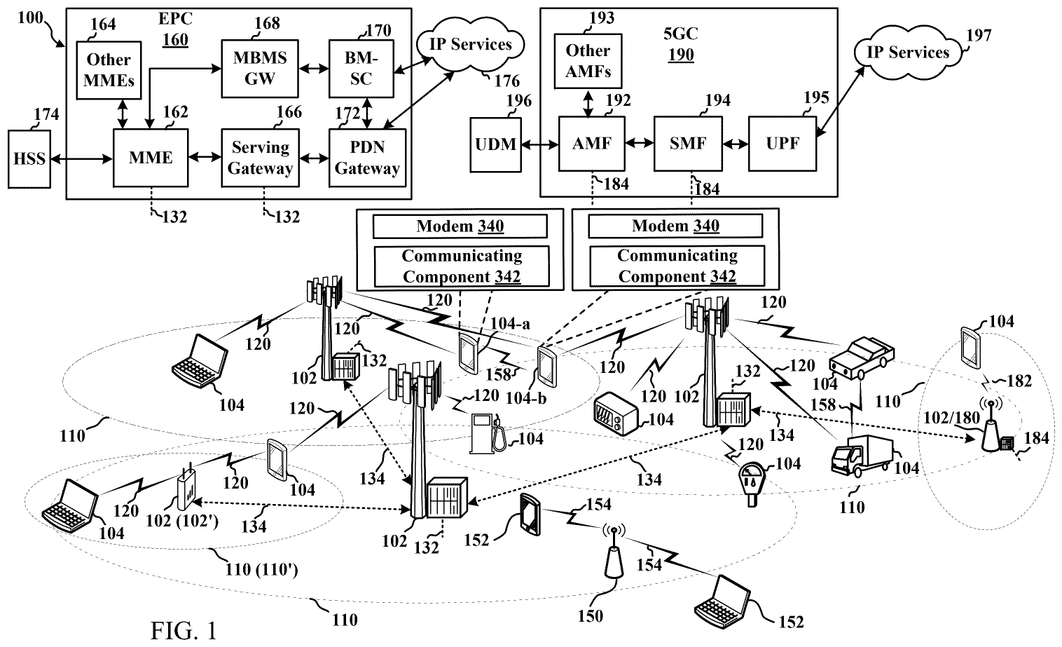

The described features will be presented in more detail below with reference to FIGS. 1-8.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets, such as data from one component interacting with another component in a local system, distributed system, and/or across a network such as the Internet with other systems by way of the signal.

Techniques described herein may be used for various wireless communication systems such as CDMA, TDMA, FDMA, OFDMA, single carrier-FDMA, and other systems. The terms “system” and “network” may often be used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM™, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies, including cellular (e.g., LTE) communications over a shared radio frequency spectrum band. The description below, however, describes an LTE/LTE-A system for purposes of example, and LTE terminology is used in much of the description below, although the techniques are applicable beyond LTE/LTE-A applications (e.g., to fifth generation (5G) new radio (NR) networks or other next generation communication systems).

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

Various aspects or features will be presented in terms of systems that can include a number of devices, components, modules, and the like. It is to be understood and appreciated that the various systems can include additional devices, components, modules, etc. and/or may not include all of the devices, components, modules etc. discussed in connection with the figures. A combination of these approaches can also be used.

FIG. 1 is a diagram illustrating an example of a wireless communications system and an access network 100. The wireless communications system (also referred to as a wireless wide area network (WWAN)) can include base stations 102, UEs 104, an Evolved Packet Core (EPC) 160, and/or a 5G Core (5GC) 190. The base stations 102 may include macro cells (high power cellular base station) and/or small cells (low power cellular base station). The macro cells can include base stations. The small cells can include femtocells, picocells, and microcells. In an example, the base stations 102 may also include gNBs 180, as described further herein. In one example, some nodes of the wireless communication system may have a modem 340 and UE communicating component 342 for selecting time periods for configuring resources for JCR signals in sidelink communications, in accordance with aspects described herein. In addition, some nodes may have a modem 440 and BS communicating component 442 for configuring UEs with resource pools for selecting resources for JCR signals, in accordance with aspects described herein. Though UE 104-a and 104-b are shown as having the modem 340 and UE communicating component 342 and a base station 102/gNB 180 is shown as having the modem 440 and BS communicating component 442, this is one illustrative example, and substantially any node or type of node may include a modem 340 and UE communicating component 342 and/or a modem 440 and BS communicating component 442 for providing corresponding functionalities described herein.

The base stations 102 configured for 4G LTE (which can collectively be referred to as Evolved Universal Mobile Telecommunications System (UMTS) Terrestrial Radio Access Network (E-UTRAN)) may interface with the EPC 160 through backhaul links 132 (e.g., using an SI interface). The base stations 102 configured for 5G NR (which can collectively be referred to as Next Generation RAN (NG-RAN)) may interface with 5GC 190 through backhaul links 184. In addition to other functions, the base stations 102 may perform one or more of the following functions: transfer of user data, radio channel ciphering and deciphering, integrity protection, head compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or 5GC 190) with each other over backhaul links 134 (e.g., using an X2 interface). The backhaul links 134 may be wired or wireless.

The base stations 102 may wirelessly communicate with one or more UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macro cells may be referred to as a heterogeneous network. A heterogeneous network may also include Home Evolved Node Bs (eNBs) (HeNBs), which may provide service to a restricted group, which can be referred to as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (e.g., for x component carriers) used for transmission in the DL and/or the UL direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

In another example, certain UEs 104 (e.g., UEs 104-a and 104-b) may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or other type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band has extremely high path loss and a short range. The mmW base station 180 may utilize beamforming 182 with the UE 104 to compensate for the extremely high path loss and short range. A base station 102 referred to herein can include a gNB 180.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The 5GC 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 can be a control node that processes the signaling between the UEs 104 and the 5GC 190. Generally, the AMF 192 can provide QoS flow and session management. User Internet protocol (IP) packets (e.g., from one or more UEs 104) can be transferred through the UPF 195. The UPF 195 can provide UE IP address allocation for one or more UEs, as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or 5GC 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). IoT UEs may include machine type communication (MTC)/enhanced MTC (eMTC, also referred to as category (CAT)-M, Cat M1) UEs, NB-IoT (also referred to as CAT NB1) UEs, as well as other types of UEs. In the present disclosure, eMTC and NB-IoT may refer to future technologies that may evolve from or may be based on these technologies. For example, eMTC may include FeMTC (further eMTC), eFeMTC (enhanced further eMTC), mMTC (massive MTC), etc., and NB-IoT may include eNB-IoT (enhanced NB-IoT), FeNB-IoT (further enhanced NB-IoT), etc. The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS, e.g., BS 102), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

In an example, UE 104-a can be a SL transmitting UE that can transmit SL communications to multiple SL receiving UEs 104-b. In this example, the SL transmitting UE 104-a can sense presence of SL communications during a sensing window and can predict resource utilization based on the sensed SL communications, which can include processing SCI to determine resource utilization in subsequent time periods. UE communicating component 342 of a SL transmitting UE 104-a can select resources for transmitting or receiving SL communications in the subsequent time periods based on the resource utilization. In an example, SL transmitting UE 104-a can indicate the resources by transmitting, to one or more SL receiving UEs 104-b, SCI to at least one of schedule resources over which the SL transmitting UE 104-a transmits SL communications to the SL receiving UEs 104-b (e.g., PSSCH communications), or schedule resources over which the one or more SL receiving UEs 104-b can transmit SL communications to the SL transmitting UEs 104-a (e.g., PSSCH communications).

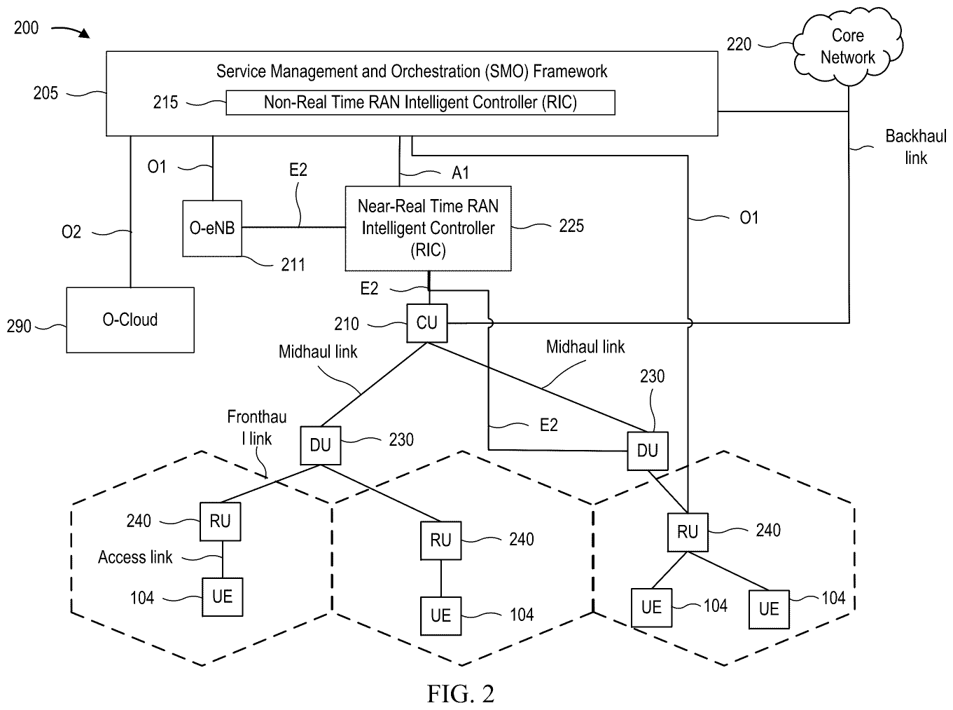

FIG. 2 shows a diagram illustrating an example of disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUS) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (i.e., Central Unit-User Plane (CU-UP)), control plane functionality (i.e., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the third Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communication with one or more UEs 104. In some implementations, real-time and non-real-time aspects of control and user plane communication with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

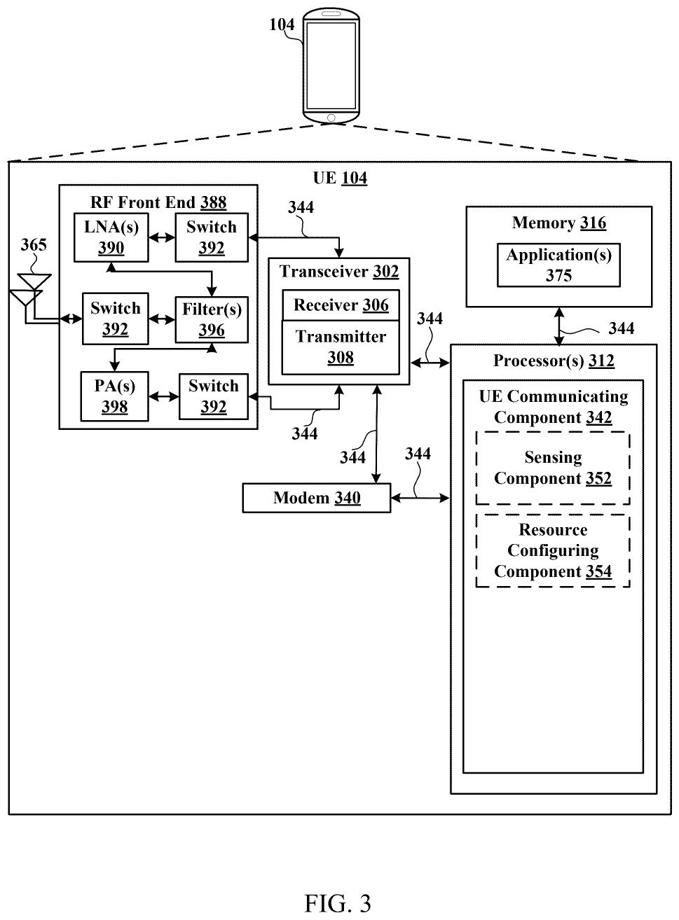

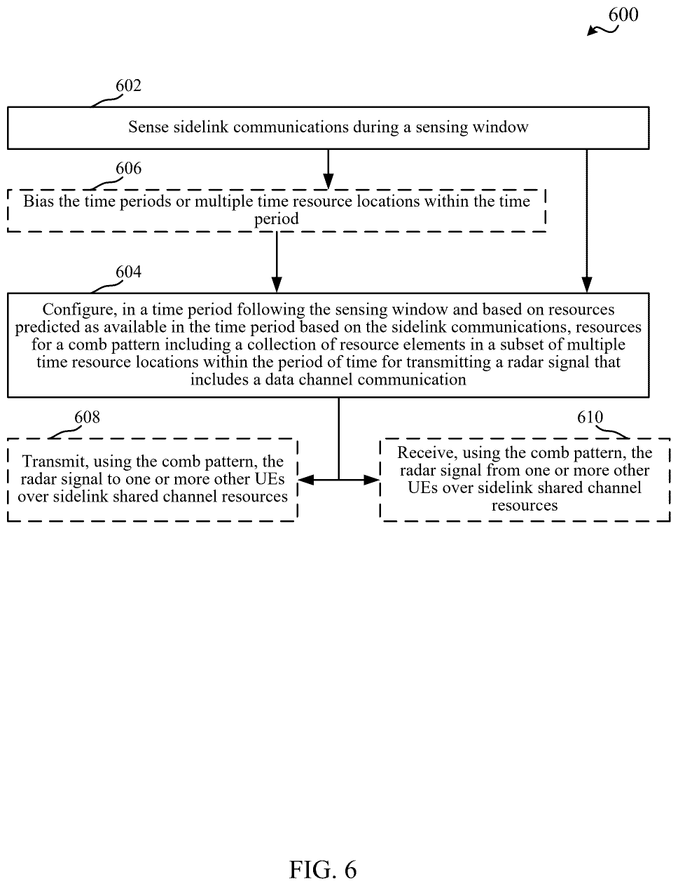

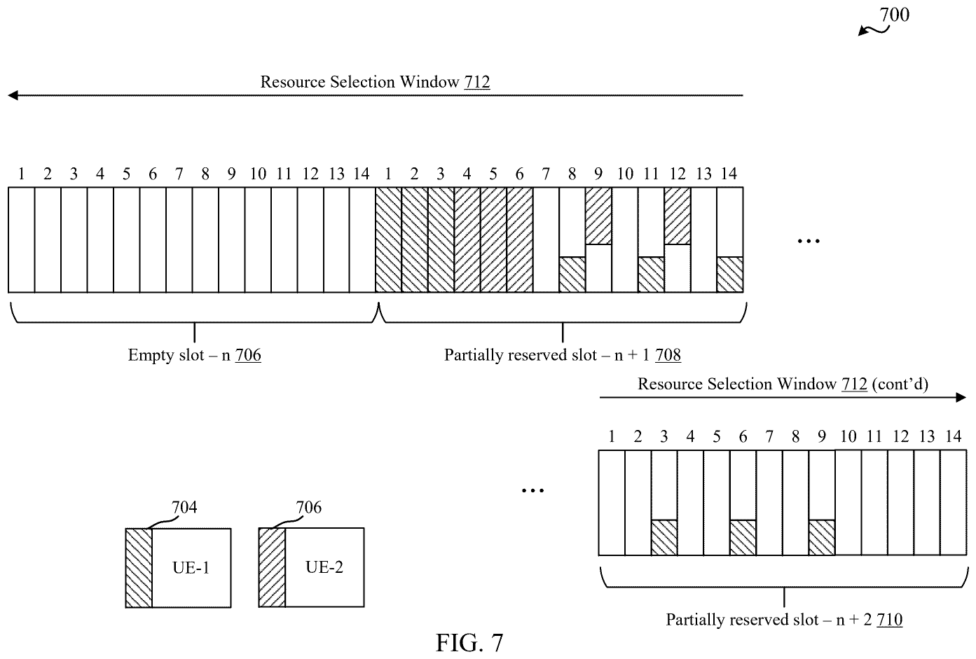

Turning now to FIGS. 3-8, aspects are depicted with reference to one or more components and one or more methods that may perform the actions or operations described herein, where aspects in dashed line may be optional. Although the operations described below in FIGS. 6-7 are presented in a particular order and/or as being performed by an example component, it should be understood that the ordering of the actions and the components performing the actions may be varied, depending on the implementation. Moreover, it should be understood that the following actions, functions, and/or described components may be performed by a specially programmed processor, a processor executing specially programmed software or computer-readable media, or by any other combination of a hardware component and/or a software component capable of performing the described actions or functions.

Referring to FIG. 3, one example of an implementation of UE 104 may include a variety of components, some of which have already been described above and are described further herein, including components such as one or more processors 312 and memory 316 and transceiver 302 in communication via one or more buses 344, which may operate in conjunction with modem 340 and/or UE communicating component 342 for selecting time periods for configuring resources for JCR signals in sidelink communications, in accordance with aspects described herein.

In an aspect, the one or more processors 312 can include a modem 340 and/or can be part of the modem 340 that uses one or more modem processors. Thus, the various functions related to UE communicating component 342 may be included in modem 340 and/or processors 312 and, in an aspect, can be executed by a single processor, while in other aspects, different ones of the functions may be executed by a combination of two or more different processors. For example, in an aspect, the one or more processors 312 may include any one or any combination of a modem processor, or a baseband processor, or a digital signal processor, or a transmit processor, or a receiver processor, or a transceiver processor associated with transceiver 302. In other aspects, some of the features of the one or more processors 312 and/or modem 340 associated with UE communicating component 342 may be performed by transceiver 302.

Also, memory 316 may be configured to store data used herein and/or local versions of applications 375 or UE communicating component 342 and/or one or more of its subcomponents being executed by at least one processor 312. Memory 316 can include any type of computer-readable medium usable by a computer or at least one processor 312, such as random access memory (RAM), read only memory (ROM), tapes, magnetic discs, optical discs, volatile memory, non-volatile memory, and any combination thereof. In an aspect, for example, memory 316 may be a non-transitory computer-readable storage medium that stores one or more computer-executable codes defining UE communicating component 342 and/or one or more of its subcomponents, and/or data associated therewith, when UE 104 is operating at least one processor 312 to execute UE communicating component 342 and/or one or more of its subcomponents.

Transceiver 302 may include at least one receiver 306 and at least one transmitter 308. Receiver 306 may include hardware, firmware, and/or software code executable by a processor for receiving data, the code comprising instructions and being stored in a memory (e.g., computer-readable medium). Receiver 306 may be, for example, a radio frequency (RF) receiver. In an aspect, receiver 306 may receive signals transmitted by at least one base station 102. Additionally, receiver 306 may process such received signals, and also may obtain measurements of the signals, such as, but not limited to, Ec/Io, signal-to-noise ratio (SNR), reference signal received power (RSRP), received signal strength indicator (RSSI), etc. Transmitter 308 may include hardware, firmware, and/or software code executable by a processor for transmitting data, the code comprising instructions and being stored in a memory (e.g., computer-readable medium). A suitable example of transmitter 308 may including, but is not limited to, an RF transmitter.

Moreover, in an aspect, UE 104 may include RF front end 388, which may operate in communication with one or more antennas 365 and transceiver 302 for receiving and transmitting radio transmissions, for example, wireless communications transmitted by at least one base station 102 or wireless transmissions transmitted by UE 104. RF front end 388 may be connected to one or more antennas 365 and can include one or more low-noise amplifiers (LNAs) 390, one or more switches 392, one or more power amplifiers (PAS) 398, and one or more filters 396 for transmitting and receiving RF signals.

In an aspect, LNA 390 can amplify a received signal at a desired output level. In an aspect, each LNA 390 may have a specified minimum and maximum gain values. In an aspect, RF front end 388 may use one or more switches 392 to select a particular LNA 390 and its specified gain value based on a desired gain value for a particular application.

Further, for example, one or more PA(s) 398 may be used by RF front end 388 to amplify a signal for an RF output at a desired output power level. In an aspect, each PA 398 may have specified minimum and maximum gain values. In an aspect, RF front end 388 may use one or more switches 392 to select a particular PA 398 and its specified gain value based on a desired gain value for a particular application.

Also, for example, one or more filters 396 can be used by RF front end 388 to filter a received signal to obtain an input RF signal. Similarly, in an aspect, for example, a respective filter 396 can be used to filter an output from a respective PA 398 to produce an output signal for transmission. In an aspect, each filter 396 can be connected to a specific LNA 390 and/or PA 398. In an aspect, RF front end 388 can use one or more switches 392 to select a transmit or receive path using a specified filter 396, LNA 390, and/or PA 398, based on a configuration as specified by transceiver 302 and/or processor 312.

As such, transceiver 302 may be configured to transmit and receive wireless signals through one or more antennas 365 via RF front end 388. In an aspect, transceiver may be tuned to operate at specified frequencies such that UE 104 can communicate with, for example, one or more base stations 102 or one or more cells associated with one or more base stations 102. In an aspect, for example, modem 340 can configure transceiver 302 to operate at a specified frequency and power level based on the UE configuration of the UE 104 and the communication protocol used by modem 340.

In an aspect, modem 340 can be a multiband-multimode modem, which can process digital data and communicate with transceiver 302 such that the digital data is sent and received using transceiver 302. In an aspect, modem 340 can be multiband and be configured to support multiple frequency bands for a specific communications protocol. In an aspect, modem 340 can be multimode and be configured to support multiple operating networks and communications protocols. In an aspect, modem 340 can control one or more components of UE 104 (e.g., RF front end 388, transceiver 302) to enable transmission and/or reception of signals from the network based on a specified modem configuration. In an aspect, the modem configuration can be based on the mode of the modem and the frequency band in use. In another aspect, the modem configuration can be based on UE configuration information associated with UE 104 as provided by the network during cell selection and/or cell reselection.

In an aspect, UE communicating component 342 can optionally include a sensing component 352 for sensing SL communications over a sensing window to predict, determine, detect, etc., resource utilization in a subsequent time period, and/or a resource configuring component 354 for configuring resources for JCR signals based on the resource utilization. In an example, where UE 104 is a SL transmitting UE, resource configuring component 354 can configure the resources for communicating with a SL receiving UE 104-b. In another example, where the UE 104 is a SL receiving UE, resource configuring component 354 can receive a configuration of resources from a SL transmitting UE 104-a that is based on the sensed SL communications and predicted resource utilization.

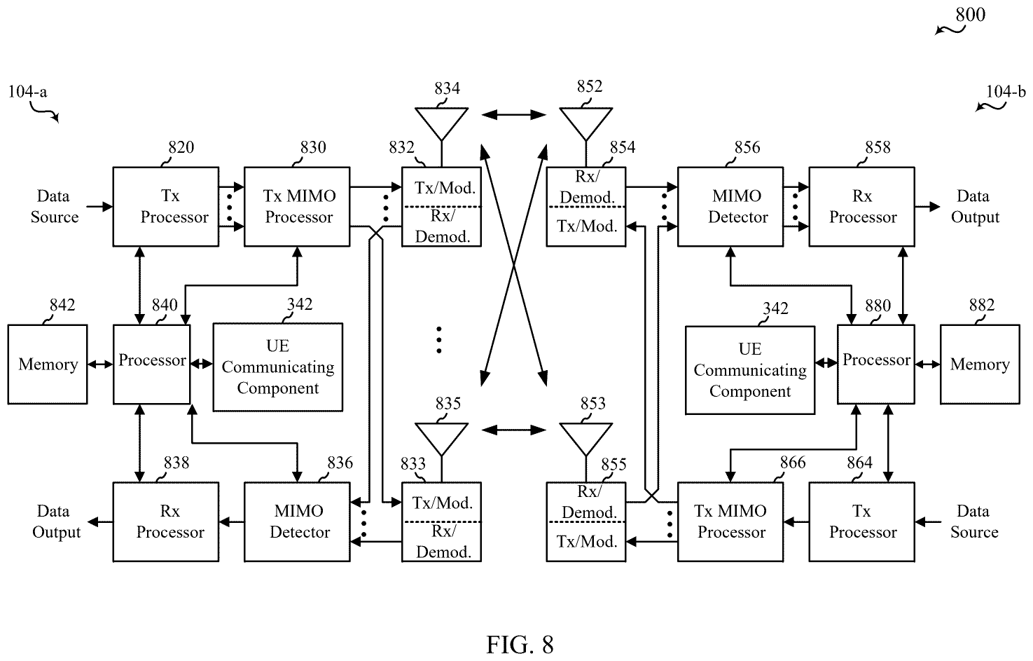

In an aspect, the processor(s) 312 may correspond to one or more of the processors described in connection with the UE in FIG. 8. Similarly, the memory 316 may correspond to the memory described in connection with the UE in FIG. 8.

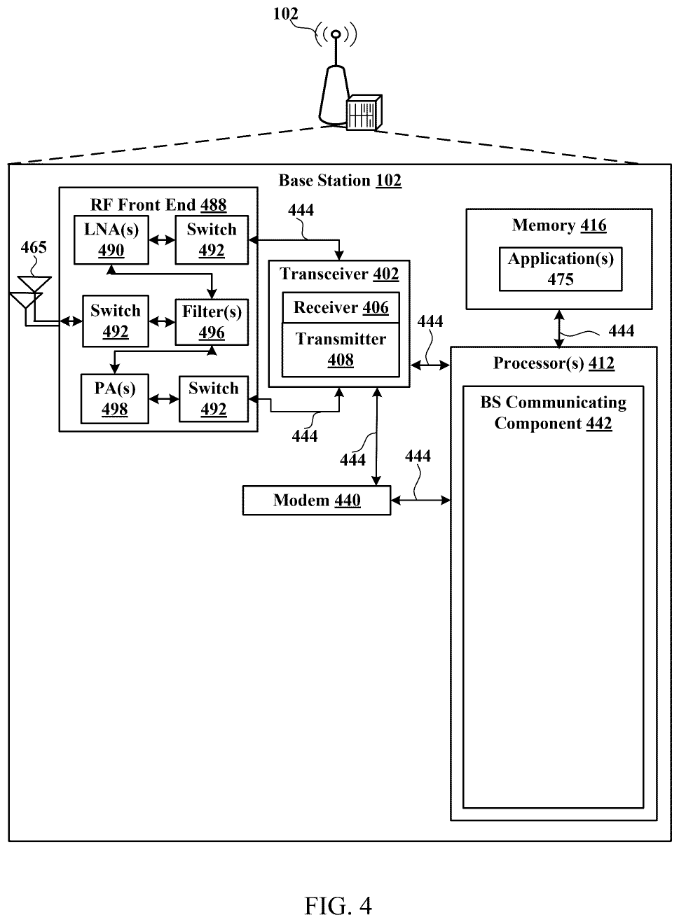

Referring to FIG. 4, one example of an implementation of base station 102 (e.g., a base station 102 and/or gNB 180, as described above) may include a variety of components, some of which have already been described above, but including components such as one or more processors 412 and memory 416 and transceiver 402 in communication via one or more buses 444, which may operate in conjunction with modem 440 and BS communicating component 442 for configuring UEs with resource pools for selecting resources for JCR signals, in accordance with aspects described herein.

The transceiver 402, receiver 406, transmitter 408, one or more processors 412, memory 416, applications 475, buses 444, RF front end 488, LNAs 490, switches 492, filters 496, PAs 498, and one or more antennas 465 may be the same as or similar to the corresponding components of UE 104, as described above, but configured or otherwise programmed for base station operations as opposed to UE operations.

In an aspect, the processor(s) 412 may correspond to one or more of the processors described in connection with the base station in FIG. 8. Similarly, the memory 416 may correspond to the memory described in connection with the base station in FIG. 8.

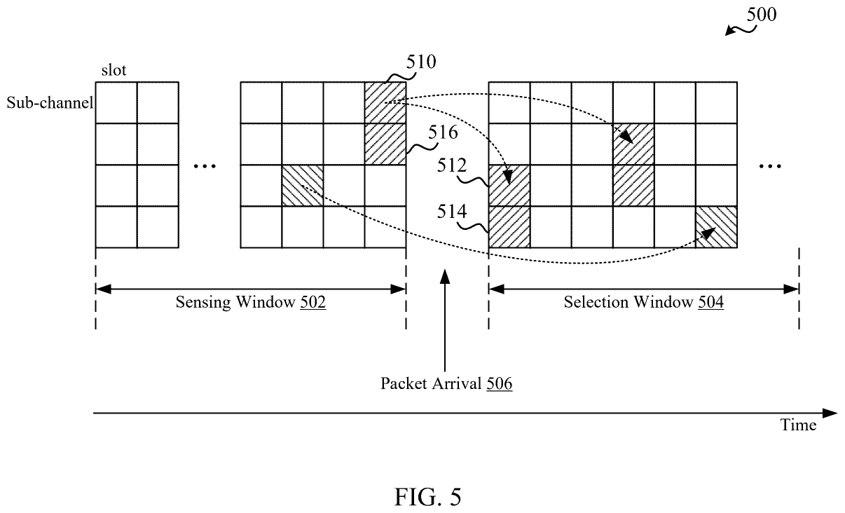

FIG. 5 illustrates an example of a sidelink resource allocation 500. Sidelink resource allocation 500 can include a Type 2 SL resource allocation where a network node can allocate a pool of resources for SL communications, and UEs can autonomously select resources from the pool of resources for SL communications. In this example, a SL transmitting UE 104-a can select resources for communicating with one or more SL receiving UEs 104-b, and can transmit SCI to the one or more SL receiving UEs 104-b to indicate the selected resources. As shown in SL resource allocation 500, a UE can access the channel based on its sensing outcomes. Specifically, the UE can identify available resources for its sidelink transmission (candidate resources) for a selection window 504 based on sensed SL communications during a sensing window 502, and can select resources for transmission from the candidate resources. In an example, a UE can reserve up to two future resources (in addition to current resource) for its transmission (e.g., for retransmission of a packet).

To identify available resources, for example, the UE can monitor and/or decode transmissions during the sensing window 502, and can perform measurement for each of the decoding (e.g., RSRP measurement). When packet arrives for transmission at 506, the UE can determine a sensing window 502 (a window in the past), can determine available resources (or utilized resources) based on SCI decoding and/or RSRP measurement in the sensing window 502, and can then identify available resources in a resource selection window 504 (a window in the future) by projecting the decoding of the SCI and/or signal measurement outcomes from the sensing window 502 to the selection window 504. For example, SCI decoding can indicate whether a resource in the selection window 504 is reserved for SL communications, and the measured RSRP may also be projected to corresponding future resource if the resource is reserved. For example, a UE can consider a resource as available if either it is not reserved (e.g., not indicated in the SCI) or is reserved but RSRP is smaller than a RSRP threshold. In this example, to select resource for transmission, a UE can use a random selection from the resources determined to be available. As described, for example, the UE can continuously (or otherwise periodically) monitor sidelink transmissions and RSRP measurement, and can perform the resource selection when a packet arrives from an upper layer for transmission.

In an example, in SL resource allocation 500, sensing window 502 can include resource element (RE) 510, which can have SCI indicating resources 512, 514, and/or other resources reserved in the selection window 504. A UE can accordingly detect the SCI and determine the REs 512, 514 as utilized and/or can measure RSRP on RE 510 (or a related RE, such as RE 516) to determine whether the RSRP is large enough to consider REs 512, 514 as utilized in the selection window 504.

Aspects described herein relate to using this SL resource allocation to determine resources for JCR signals. For example, communications between devices in automobiles can benefit from high density of radars with high-resolution and high-update rate. Phase sensing can include single phase sensing, which may lead to large communication overhead with back-to-back comb transmission. In single phase sensing, a UE can be configured with a coherent processing interval (CPI, also referred to as a radar frame) during which the UE can sense a radar signal. In this example, with a 20 frame per second update rate (50 millisecond sensing period), more than 10% of the system resources can be used per beam and per UE.

Phase sensing can include multi-phase sensing, which may enable radar sensing with low data rate overhead with sparse comb pattern. For example, in a first (scanning) phase, target presence can be detected with low resolution, and in a second (tracking) phase, target direction for detected targets can be refined with high resolution. The CPI for the scanning phase can be smaller than that used in single phase sensing, and the overhead can still be smaller than single phase scanning—e.g., with a 20 frame per second update rate, than 4.5% of the system resources can be used per beam and per UE, and 9% of system resources per user can be used assuming two targets within field of view (FoV).

In 5G NR, interlaced channel structure can be used for sidelink communications in unlicensed band, which can allow for achieving occupied channel bandwidth (OCB) requirements. A transmission from a SL UE can occupy one or multiple interlaced resource RB groups, where one interlaced RB group includes RBs that are evenly spaced in frequency within the available channel bandwidth. In 5G NR, the interlaced pattern is adopted with uniform spacing for entire channel bandwidth, and this structure may not be sufficient and flexible enough to reduce communication data rate for radar sensing with desired requirements. Accordingly, aspects described herein relate to a time (and/or frequency) comb pattern for a UE, which can be configured for the UE by a base station (e.g., in type 1 sidelink resource allocation) or otherwise selected by the UE (e.g., in type 2 sidelink resource allocation). The time comb pattern can include enhanced uniform and/or non-uniform comb patterns within a configurable transmission window of time of the UE. In another example, the time comb pattern may be such that UEs may or may not overlap in time periods for transmissions.

When UEs use such time and/or frequency comb reservation, there may be some resources that are completely empty or unused (e.g., are not utilized by any nearby UEs) and/or resources that have some REs (e.g., REs 512, 514) sensed as reserved. In such examples, a UE can select from the empty or partially reserved resources using biased resource allocation for JCR with time and/or frequency data comb transmission. For example, a UE can select resources among the available resources that are either completely empty or are partially reserved to alleviate collision issue in resource selection, which may depend on priority and percentage of REs available in different resources.

FIG. 6 illustrates a flow chart of an example of a method 600 for selecting resources for transmitting or receiving a JCR signal as a radar signal that includes sidelink communications, in accordance with aspects described herein. In an example, a UE functioning as a SL transmitting UE 104-a in sidelink communications, or a UE functioning as a SL receiving UE 104-b in sidelink communications, can perform the functions described in method 600 using one or more of the components described in FIGS. 1 and 3.

In method 600, at Block 602, sidelink communications can be sensed during a sensing window. In an aspect, sensing component 352, e.g., in conjunction with processor(s) 312, memory 316, transceiver 302, UE communicating component 342, etc., of a SL transmitting UE 104-a or a SL receiving UE 104-b, can sense sidelink communications during a sensing window. In an example, sensing component 352 can sense the sidelink communications continuously or periodically (e.g., based on a period configured by a network node or another UE in RRC signaling, etc.), and/or can sense the sidelink communications based on detecting arrival of a packet from a higher layer of the UE 104 for transmitting to another UE, etc. In another example, sensing component 352 can sense the sidelink communications based on detecting a time instance for sending a radar signal, which can be periodically configured, as described above, for radar sensing. In an example, sensing component 352 can determine a sensing window over which to sense SL communications as a certain time period before the packet arrival, radar period, etc.

In method 600, at Block 604, resources for a comb pattern can be configured, in a time period following the sensing window and based on resources predicted as available in the time period based on sidelink communications, including a collection of REs in a subset of multiple time resource locations within the period of time for transmitting a radar signal that includes a data channel communication. In an aspect, resource configuring component 354, e.g., in conjunction with processor(s) 312, memory 316, transceiver 302, UE communicating component 342, etc., of a SL transmitting UE 104-a or a SL receiving UE 104-b, can configure, in the time period following the sensing window and based on resources predicted as available in the time period based on sidelink communications, resources for a comb pattern including the collection of resource elements in the subset of multiple time resource locations within the period of time for transmitting the radar signal that includes the data channel communication (e.g., the JCR signal). For example, resource configuring component 354 can configure the resources by, or based on, selecting the resources from a selection window based on the SL communications sensed during the sensing window, as described above and further herein. In another example, resource configuring component 354 can configure the resources by, or based on, transmitting SCI to one or more SL receiving UEs 104-b to indicate the resources over which SL communications can occur with the UE 104.

In one example, resource configuring component 354 can configure resources for SL communications that are in time periods predicted to have no transmission from other UEs based on the sensed SL communications, in time periods predicted to have the least number of REs used for transmission from other UEs based on the sensed SL communications, etc. For example, as described, SL communications in the sensing window can use a time and/or frequency comb structure, and thus the portions of a time period used for SL communications can vary per time period. As such, sensing component 352 can sense how many REs or an RE utilization density (or RE density) of each time period that is scheduled for SL communications, and can accordingly select time periods based on the RE density. In addition, for example, resource configuring component 354 can configure the resources for SL communications in a comb structure in time and/or in frequency. In an example, after selecting the resources, as described, resource configuring component 354 can indicate the selected resources to one or more SL receiving UEs in SCI.

In one example, resource configuring component 354 can configure the resources using biasing to bias certain resources or time periods based on RE density, based on a priority of the SL communications to be scheduled (e.g., of the arrived packet), etc. In an example, in method 600, optionally at Block 606, the time periods or multiple time resource locations within the time period can be biased. In an aspect, resource configuring component 354, e.g., in conjunction with processor(s) 312, memory 316, transceiver 302, UE communicating component 342, etc., of a SL transmitting UE 104-a or a SL receiving UE 104-b, can bias the time periods or the multiple time resource locations within the time period, which can be based on a probability that the resources are selected. For example, resource configuring component 354 can select the resources for configuration based on the biasing.

In one example, resource configuring component 354 can determine a priority of data traffic, such as a priority associated with a buffer or application from which the data arrives, a priority associated with a bearer over which the data is to be transmitted, etc. if the UE has high priority data traffic, resource configuring component 354 can prioritize selecting empty resources (time periods without any reserved REs from other sensing/JCR UEs). For example, biased resource selection may be applied only if priority is higher than a priority threshold (e.g., otherwise the resources may be treated equally). In another example, the higher the traffic priority, the larger a difference between a probability P_{A} and a probability P_{B}, as defined below. For example, when resource configuring component 354 performs resource selection, it can select a resource with probability P_{A}, if the resource is completely empty (e.g., if no REs have been allocated to other UEs), and when resource configuring component 354 performs resource selection, it can select a resource with probability P_{B}, if the resource is partially reserved (e.g., a few REs have been allocated to other UEs for sensing or JCR purpose). P_{A}>P_{B} and P_{A}−P_{B} can be larger for UE with higher priority data. In another example, a UE with low priority data can prioritize selecting partially empty resources for further improvement of the resource selection for all UEs. For example, P_{A}<P_{B} if priority is below a low priority threshold. One benefit of combining priority may be to alleviate over-booking (or higher collision) issue in resources without sensing/JCR REs.

In another example, the probability that a resource is selected can be a function of number of REs available in that resource for data transmission. For example, different resources may have different number of REs occupied by sensing/JCR UEs. For example, in some slot there may be two UEs sending sensing reference signals (RS), while in some other slots there is only one UE sending sensing RS. In an example, probability that a resource is selected can be a function of number of REs available for data transmission, so resources with more REs occupied by sensing RS can be deprioritized. For example, Pₙ∝(100−Xₙ), where Xₙ is the percentage of a number of REs occupied by other UEs in resource n with comb transmission. For example, resource configuring component 354 may select the resources based on the probability. In another example, resource availability can also be dependent on number of REs available in that resource. For instance, if too many UEs are reserving REs in a resource, resource configuring component 354 may exclude the resource from candidate resources for selection. In yet another example, the probability that a resource is selected may be a combined function of data traffic priority and number of REs available for data transmission. Examples of various aspects are shown in FIG. 7.

FIG. 7 illustrates an example of a SL resource allocation 700 in a resource selection window, in accordance with aspects described herein. For example, SL resource allocation 700 can include resources scheduled for SL communications for UE-1 704 (e.g., transmissions to one or more SL receiving UEs or receptions from the one or more SL receiving UEs) or SL communications for UE-2 706. SL resource allocation 700 can include an empty slot 706, a partially reserved slot 708 with a first RE density, and another partially reserved slot 710 with a second RE density that is less than the first RE density. In one example, the SL resource allocation 700 can be sensed based on a previous sensing window indicating resources allocated in the resource selection window 712.

In accordance with some examples described above, if another UE determining resources for scheduled SL communications, UE-3, has higher traffic priority above a priority threshold, resource configuring component 354 of UE-3 can choose empty slot n 706 with higher probability (P_{A}) than other slots (e.g., partially reserved slot n+1 708 and/or partially reserved slot n+2 710) with probability P_{B}=P_{A}−η_{priority}, where η_{priority} can be a polynomial function of traffic priority. In an example, coefficients of this function can either be provided semi-statically using RRC signaling from a network node, or dynamically using media access control-control element (MAC-CE) or downlink control information (DCI) signaling, etc. from the network node, or through resource pool level configuration from the network node.

In accordance with other examples described above, UE-3 can choose slot n 706 with highest probability, followed by partially reserved slot n+2 710. UE-3 can choose the partially reserved slot n+1 708 with least priority. In this example, Pₙ>Pₙ₊₂>Pₙ₊₁. Here, Pₖ=ƒ(Xₖ), where the coefficients of polynomial function ƒ(Xₙ) can be provided semi-statically using RRC signaling from a network node, or dynamically using MAC-CE or DCI signaling from the network node, or through resource pool level configuration from the network node. In yet another example, UE-3 with higher traffic priority above a priority threshold can choose empty slot 706 with priority Pₙ>Pₙ₊₂>Pₙ₊₁, where Pₖ=ƒ(Xₖ, η_{priority}).

In examples described herein, the time resource locations can refer to slots, symbols within the slots, etc., and the time period can refer to the resource selection window, slots, etc. In one example, the time period can be the resource selection window including multiple slots, and the UE can configure resources in the time resource locations including one or more of the slots based on biasing the slots or otherwise prioritizing the slots, symbols within the slots, REs within the symbols, and/or the like.

In method 600, optionally at Block 608, the radar signal can be transmitted, using the comb pattern, to one or more other UEs over sidelink shared channel resources. In an aspect, UE communicating component 342, e.g., in conjunction with processor(s) 312, memory 316, transceiver 302, etc., of a SL transmitting UE 104-a, can transmit, using the comb pattern, the radar signal to the one or more other UEs over sidelink shared channel resources (e.g., over PSSCH). For example, as described, resource configuring component 354 can configure a comb pattern for the resources for SL communications using a time and/or frequency comb pattern and based on the predicted resource utilization, as described above, and UE communicating component 342 can transmit SL communications to one or more SL receiving UEs 104-b over the resources in the time and/or frequency comb pattern. In addition, as described, UE communicating component 342 can transmit, to the one or more SL receiving UEs 104-b, SCI indicating the time and/or frequency comb pattern and/or more parameters for determining the time and/or frequency comb pattern, such as a time periodicity for the comb pattern, a starting symbols, stop symbol index, number of repetitions in time, frequency periodicity, a starting subcarrier, stop subcarrier index, number of repetitions in frequency, etc. SL receiving UEs 104-b can accordingly receive the SCI and determine the resources for receiving SL communications from the SL transmitting UE 104-a and/or transmitting SL communications to the SL transmitting UE 104-a.

In method 600, optionally at Block 610, the radar signal can be received, using the comb pattern, from one or more other UEs over sidelink shared channel resources. In an aspect, UE communicating component 342, e.g., in conjunction with processor(s) 312, memory 316, transceiver 302, etc., of a SL receiving UE 104-b, can receive, using the comb pattern, the radar signal from the one or more other UEs over the sidelink shared channel resources (e.g., PSSCH resources). For example, as described, this may be based on SL receiving UE 104-b determining the resources, as described above, based on receiving an indication of the resources in SCI, etc. In any case, UE communicating component 342 can determine the resources of the comb pattern used by the SL transmitting UE 104-a and can accordingly receive JCR signals from the SL transmitting UE 104-a.

FIG. 8 is a block diagram of a MIMO communication system 800 including UEs 104-a, 104-b. The MIMO communication system 800 may illustrate aspects of the wireless communication access network 100 described with reference to FIG. 1. The UE 104-a may be an example of aspects of the UE 104 described with reference to FIGS. 1 and 3. The UE 104-a may be equipped with antennas 834 and 835, and the UE 104-b may be equipped with antennas 852 and 853. In the MIMO communication system 800, the UEs 104-a, 104-b may be able to send data over multiple communication links at the same time. Each communication link may be called a “layer” and the “rank” of the communication link may indicate the number of layers used for communication. For example, in a 2×2 MIMO communication system where UE 104-a transmits two “layers,” the rank of the communication link between the UE 104-a and the UE 104-b is two.

At the UE 104-a, a transmit (Tx) processor 820 may receive data from a data source. The transmit processor 820 may process the data. The transmit processor 820 may also generate control symbols or reference symbols. A transmit MIMO processor 830 may perform spatial processing (e.g., precoding) on data symbols, control symbols, or reference symbols, if applicable, and may provide output symbol streams to the transmit modulator/demodulators 832 and 833. Each modulator/demodulator 832 through 833 may process a respective output symbol stream (e.g., for OFDM, etc.) to obtain an output sample stream. Each modulator/demodulator 832 through 833 may further process (e.g., convert to analog, amplify, filter, and upconvert) the output sample stream to obtain a DL signal. In one example, DL signals from modulator/demodulators 832 and 833 may be transmitted via the antennas 834 and 835, respectively.

The UE 104-b may be an example of aspects of the UEs 104 described with reference to FIGS. 1 and 3. At the UE 104-b, the UE antennas 852 and 853 may receive the signals from the UE 104-a (e.g., over a sidelink) and may provide the received signals to the modulator/demodulators 854 and 855, respectively. Each modulator/demodulator 854 through 855 may condition (e.g., filter, amplify, downconvert, and digitize) a respective received signal to obtain input samples. Each modulator/demodulator 854 through 855 may further process the input samples (e.g., for OFDM, etc.) to obtain received symbols. A MIMO detector 856 may obtain received symbols from the modulator/demodulators 854 and 855, perform MIMO detection on the received symbols, if applicable, and provide detected symbols. A receive (Rx) processor 858 may process (e.g., demodulate, deinterleave, and decode) the detected symbols, providing decoded data for the UE 104-b to a data output, and provide decoded control information to a processor 880, or memory 882.

At the UE 104-b, a transmit processor 864 may receive and process data from a data source. The transmit processor 864 may also generate reference symbols for a reference signal. The symbols from the transmit processor 864 may be precoded by a transmit MIMO processor 866 if applicable, further processed by the modulator/demodulators 854 and 855 (e.g., for SC-FDMA, etc.), and be transmitted to the UE 104-a in accordance with the communication parameters received from the UE 104-a. At the UE 104-a, the signals from the UE 104-b may be received by the antennas 834 and 835, processed by the modulator/demodulators 832 and 833, detected by a MIMO detector 836 if applicable, and further processed by a receive processor 838. The receive processor 838 may provide decoded data to a data output and to the processor 840 or memory 842.

The processor 840 and/or 880 may in some cases execute stored instructions to instantiate a UE communicating component 342 (see e.g., FIGS. 1 and 3).

The components of the UEs 104-a, 104-b may, individually or collectively, be implemented with one or more ASICs adapted to perform some or all of the applicable functions in hardware. Each of the noted modules may be a means for performing one or more functions related to operation of the MIMO communication system 800. Similarly, the components of the UE 104-a may, individually or collectively, be implemented with one or more ASICs adapted to perform some or all of the applicable functions in hardware. Each of the noted components may be a means for performing one or more functions related to operation of the MIMO communication system 800.

The following aspects are illustrative only and aspects thereof may be combined with aspects of other embodiments or teaching described herein, without limitation.

Aspect 1 is a method for wireless communication at a UE including sensing sidelink communications during a sensing window, configuring, in a time period following the sensing window and based on resources predicted as available in the time period based on the sidelink communications, resources for a comb pattern including a collection of resource elements in a subset of multiple time resource locations within the time period for transmitting a radar signal that includes a data channel communication, and one of transmitting, using the comb pattern, the radar signal to one or more other UEs over sidelink shared channel resources, or receiving, using the comb pattern, the radar signal from one or more other UEs over sidelink shared channel resources.

In Aspect 2, the method of Aspect 1 includes biasing the multiple time resource locations within the time period based on the sidelink communications sensed during the sensing window and based on a priority of the data channel communication, where configuring the resources for the comb pattern including the subset of multiple time resource locations is based on the multiple time resource locations as biased.

In Aspect 3, the method of Aspect 2 includes where biasing the multiple time resource locations includes biasing the multiple time resource locations with a first probability that the resource elements in the multiple time resource locations are unused based on the sidelink communications sensed during the sensing window, where the priority of the data channel communication achieves a high priority threshold.

In Aspect 4, the method of Aspect 3 includes where biasing the multiple time resource locations includes biasing the multiple time resource locations with a second probability that at least some of the resource elements in the multiple time resource locations are used based on the sidelink communications sensed during the sensing window.

In Aspect 5, the method of Aspect 4 includes where at least one of the first probability, the second probability, or a difference between the first probability and the second probability is based on the priority of the data channel communication.

In Aspect 6, the method of any of Aspects 2 to 5 includes where biasing the multiple time resource locations includes biasing the multiple time resource locations with a first probability that the resource elements in the multiple time resource locations are used based on the sidelink communications sensed during the sensing window, where the priority of the data channel communication is below a low priority threshold.

In Aspect 7, the method of any of Aspects 1 to 6 includes biasing the multiple time resource locations within the time period based on a number of resource elements available in the multiple time resource locations, where configuring the resources for the comb pattern including the subset of multiple time resource locations is based on the multiple time resource locations as biased.

In Aspect 8, the method of Aspect 7 includes where configuring the resources for the comb pattern includes excluding, from the multiple time resource locations, other time resource locations sensed to have at least a threshold number of other UEs transmitting the sidelink communications.

In Aspect 9, the method of any of Aspects 1 to 8 includes biasing the multiple time resource locations within the time period based on a priority of the data channel communication and based on a number of resource elements available in the multiple time resource locations, where configuring the resources for the comb pattern including the subset of multiple time resource locations is based on the multiple time resource locations as biased.

Aspect 10 is an apparatus for wireless communication including a processor, memory coupled with the processor, and instructions stored in the memory and operable, when executed by the processor, to cause the apparatus to perform any of the methods of Aspects 1 to 9.

Aspect 11 is an apparatus for wireless communication including means for performing any of the methods of Aspects 1 to 9.

Aspect 12 is a computer-readable medium including code executable by one or more processors for wireless communications, the code including code for performing any of the methods of Aspects 1 to 9.

The above detailed description set forth above in connection with the appended drawings describes examples and does not represent the only examples that may be implemented or that are within the scope of the claims. The term “example,” when used in this description, means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, computer-executable code or instructions stored on a computer-readable medium, or any combination thereof.

The various illustrative blocks and components described in connection with the disclosure herein may be implemented or performed with a specially programmed device, such as but not limited to a processor, a digital signal processor (DSP), an ASIC, a field programmable gate array (FPGA) or other programmable logic device, a discrete gate or transistor logic, a discrete hardware component, or any combination thereof designed to perform the functions described herein. A specially programmed processor may be a microprocessor, but in the alternative, the processor may be any conventional processor, controller, microcontroller, or state machine. A specially programmed processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a non-transitory computer-readable medium. Other examples and implementations are within the scope and spirit of the disclosure and appended claims. For example, due to the nature of software, functions described above can be implemented using software executed by a specially programmed processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise. Thus, the disclosure is not to be limited to the examples and designs described herein but is to be accorded the widest scope consistent with the principles and novel features disclosed herein.

1. An apparatus for wireless communication, comprising:
one or more processors;
one or more memories coupled with the one or more processors; and
instructions stored in the one or more memories and operable, when executed by the one or more processors, to cause the apparatus to:
sense sidelink communications during a sensing window;
configure, in a time period following the sensing window and based on resources predicted as available in the time period based on the sidelink communications, resources for a comb pattern including a collection of resource elements in a subset of multiple time resource locations within the time period for transmitting a radar signal that includes a data channel communication; and
one of:
transmit, using the comb pattern, the radar signal to one or more other UEs over sidelink shared channel resources; or
receive, using the comb pattern, the radar signal from one or more other UEs over sidelink shared channel resources.

2. The apparatus of claim 1, wherein the instructions, when executed by the one or more processors, cause the apparatus to bias the multiple time resource locations within the time period based on the sidelink communications sensed during the sensing window and based on a priority of the data channel communication, wherein the instructions, when executed by the one or more processors, cause the apparatus to configure the resources for the comb pattern including the subset of multiple time resource locations based on the multiple time resource locations as biased.

3. The apparatus of claim 2, wherein the instructions, when executed by the one or more processors, cause the apparatus to bias the multiple time resource locations with a first probability that the resource elements in the multiple time resource locations are unused based on the sidelink communications sensed during the sensing window, wherein the priority of the data channel communication achieves a high priority threshold.

4. The apparatus of claim 3, wherein the instructions, when executed by the one or more processors, cause the apparatus to bias the multiple time resource locations with a second probability that at least some of the resource elements in the multiple time resource locations are used based on the sidelink communications sensed during the sensing window.

5. The apparatus of claim 4, wherein at least one of the first probability, the second probability, or a difference between the first probability and the second probability is based on the priority of the data channel communication.

6. The apparatus of claim 2, wherein the instructions, when executed by the one or more processors, cause the apparatus to bias the multiple time resource locations with a first probability that the resource elements in the multiple time resource locations are used based on the sidelink communications sensed during the sensing window, wherein the priority of the data channel communication is below a low priority threshold.

7. The apparatus of claim 1, wherein the instructions, when executed by the one or more processors, cause the apparatus to bias the multiple time resource locations within the time period based on a number of resource elements available in the multiple time resource locations, wherein the instructions, when executed by the one or more processors, cause the apparatus to configure the resources for the comb pattern including the subset of multiple time resource locations based on the multiple time resource locations as biased.

8. The apparatus of claim 7, wherein the instructions, when executed by the one or more processors, cause the apparatus to configure the resources for the comb pattern at least in part by excluding, from the multiple time resource locations, other time resource locations sensed to have at least a threshold number of other UEs transmitting the sidelink communications.

9. The apparatus of claim 1, wherein the instructions, when executed by the one or more processors, cause the apparatus to bias the multiple time resource locations within the time period based on a priority of the data channel communication and based on a number of resource elements available in the multiple time resource locations, wherein the instructions, when executed by the one or more processors, cause the apparatus to configure the resources for the comb pattern including the subset of multiple time resource locations based on the multiple time resource locations as biased.

10. A method for wireless communication at a user equipment (UE), comprising:
sensing sidelink communications during a sensing window;
configuring, in a time period following the sensing window and based on resources predicted as available in the time period based on the sidelink communications, resources for a comb pattern including a collection of resource elements in a subset of multiple time resource locations within the time period for transmitting a radar signal that includes a data channel communication; and
one of:
transmitting, using the comb pattern, the radar signal to one or more other UEs over sidelink shared channel resources; or
receiving, using the comb pattern, the radar signal from one or more other UEs over sidelink shared channel resources.

11. The method of claim 10, further comprising biasing the multiple time resource locations within the time period based on the sidelink communications sensed during the sensing window and based on a priority of the data channel communication, wherein configuring the resources for the comb pattern including the subset of multiple time resource locations is based on the multiple time resource locations as biased.

12. The method of claim 11, wherein biasing the multiple time resource locations includes biasing the multiple time resource locations with a first probability that the resource elements in the multiple time resource locations are unused based on the sidelink communications sensed during the sensing window, wherein the priority of the data channel communication achieves a high priority threshold.

13. The method of claim 12, wherein biasing the multiple time resource locations includes biasing the multiple time resource locations with a second probability that at least some of the resource elements in the multiple time resource locations are used based on the sidelink communications sensed during the sensing window.

14. The method of claim 13, wherein at least one of the first probability, the second probability, or a difference between the first probability and the second probability is based on the priority of the data channel communication.

15. The method of claim 11, wherein biasing the multiple time resource locations includes biasing the multiple time resource locations with a first probability that the resource elements in the multiple time resource locations are used based on the sidelink communications sensed during the sensing window, wherein the priority of the data channel communication is below a low priority threshold.

16. The method of claim 10, further comprising biasing the multiple time resource locations within the time period based on a number of resource elements available in the multiple time resource locations, wherein configuring the resources for the comb pattern including the subset of multiple time resource locations is based on the multiple time resource locations as biased.

17. The method of claim 16, wherein configuring the resources for the comb pattern includes excluding, from the multiple time resource locations, other time resource locations sensed to have at least a threshold number of other UEs transmitting the sidelink communications.

18. The method of claim 10, further comprising biasing the multiple time resource locations within the time period based on a priority of the data channel communication and based on a number of resource elements available in the multiple time resource locations, wherein configuring the resources for the comb pattern including the subset of multiple time resource locations is based on the multiple time resource locations as biased.

19. An apparatus for wireless communication, comprising:
means for sensing sidelink communications during a sensing window;
means for configuring, in a time period following the sensing window and based on resources predicted as available in the time period based on the sidelink communications, resources for a comb pattern including a collection of resource elements in a subset of multiple time resource locations within the time period for transmitting a radar signal that includes a data channel communication; and
means for one of:
transmitting, using the comb pattern, the radar signal to one or more other UEs over sidelink shared channel resources; or
receiving, using the comb pattern, the radar signal from one or more other UEs over sidelink shared channel resources.

20. The apparatus of claim 19, further comprising means for biasing the multiple time resource locations within the time period based on the sidelink communications sensed during the sensing window and based on a priority of the data channel communication, wherein the means for configuring configures the resources for the comb pattern including the subset of multiple time resource locations based on the multiple time resource locations as biased.

21-30. (canceled)
